(19) United States
(12) Patent Application Publication
(10) Pub. No.: US 2005/0023296 A1
(43) Pub. Date: Feb. 3, 2005

(54) Heated pump system for delivering multiple components in a predetermined ratio to a spray applicator

(76) Inventor: Frank C. Bien, Apopka, FL (US)

Correspondence Address: DANIEL S. POLLEY, ESQ., 1215 EAST BROWARD BOULEVARD, FORT LAUDERDALE, FL, 33301, US

(21) Appl. No.: 10/862,771

(22) Filed: Jun. 7, 2004

Related U.S. Application Data
(60) Provisional application No. 60/476,577, filed on Jun. 7, 2003.

(51) Int. Cl. B67D 5/62

(52) U.S. Cl. 222/146.1

(57) ABSTRACT

A heated pump assembly having a proportioner pump that pumps components in a preselected ratio from their storage drums. The first component is drawn from its storage drum and divided into two portions, one portion going to a first supply tube and one portion going to third supply tube. The first portion travels from the first supply tube to a first primary heater and the second portion travels through the third supply tube to a second primary heater. The two portions of the first component are combined and sent to a final heater. After traveling through the final heater, the heated first component is sent to the spray applicator, preferably through a heated hose. The second component is sent by the assembly as the second input to the spray applicator.

This application claims the benefit of and priority to U.S. Application Ser. No. 60/476,577, filed Jun. 7, 2003.

### BACKGROUND OF THE INVENTION

1. Field of the Invention

This invention relates to a pump system for delivering multiple components to an applicator, and particularly to a pneumatic pump system for the separate delivery of multiple components in a predetermined ratio to a spray applicator assembly where the in situ generation, mixing and application of the multiple component composition is form for use as coatings, sealants, adhesives, etc. The compositions can be used in many applications, including, but not limited to, roofing, coverings, weatherproofing, rust prevention, corrosion prevention and construction waterproofing applications.

2. Description of Related Art

Due to the nature of the materials used in forming bituminous polyurethane interpenetrating elastomeric network compositions, as well as other compositions, specialized equipment is required to mix and apply the materials to form the composition. This equipment must be portable so as to allow it to be taken to the job site, on elevators or any other designated area.

Various systems and devices for preparing materials, such as asphalt, are known. However, the prior art fails to provide for an applicator system, which, permits the separate delivery of an asphalt/polyol combination in predetermined ratio with other materials, such as but not limited to, isocyanate, to an applicator where it is mixed and sprayed form a multiple component composition, which is created just prior to application or in situ. It is therefore to the effective resolution of the shortcomings of the prior art that the present invention is directed.

### BRIEF SUMMARY OF THE INVENTION

A heat pump system for delivering multiple components in a predetermined ratio to an applicator is disclosed for use as coating, weatherproofing or sealing compositions, or other compositions or material(s). The various components of the system are securely attached or mounted onto one or more frames for ease in transportation of the system. A complete disclosure of the invention is provided in the Detailed Description and Drawings.

It is an object of the present invention is to provide a novel pumping, heating, metering, mixing, and spraying system for plural material compositions.

It is another object of the present invention to provide a novel system for spraying plural material compositions at or near the site of application.

In accordance with these and other objects, which will become apparent hereinafter, the instant invention will now be described with particular reference to the accompanying drawing.

### BRIEF DESCRIPTION OF THE FIGURE

FIG. 1 is a perspective view of the pump system and power assembly of the present invention;

FIG. 2 is a front perspective view of the pump system of FIG. 1;

FIG. 3 is a back perspective view of the pump system of FIG. 1;

FIG. 4 is a front view of the second embodiment of the pump system in accordance with the present invention;

FIG. 5 is a perspective back view of the second embodiment;

FIG. 6 is a perspective front view of the second embodiment;

FIG. 7 is a back view of the second embodiment;

FIGS. 8 and 9 are various views of a frame which can be used with the second embodiment of the invention;

FIG. 10 is another back view of the second embodiment;

FIG. 11 is a first side view of the second embodiment;

FIG. 12 is a front view of the second embodiment; and

FIG. 13 is second side view of the second embodiment.

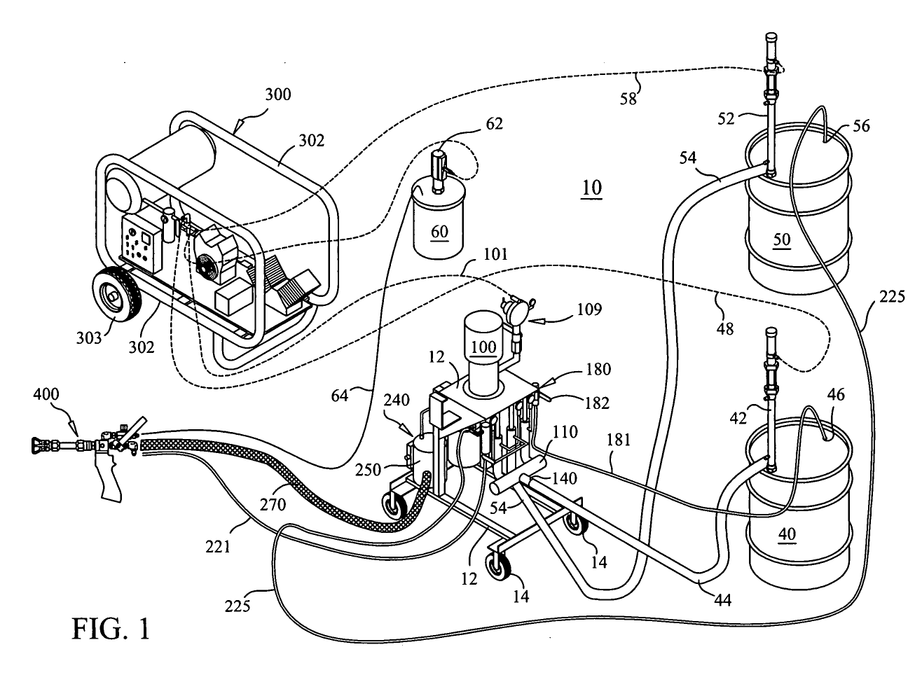

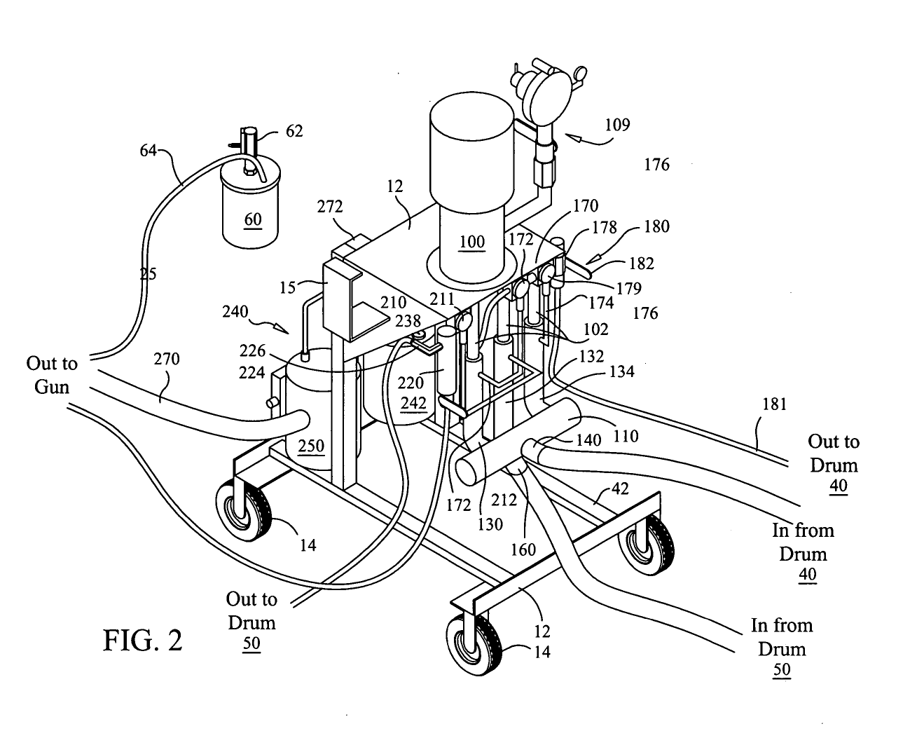

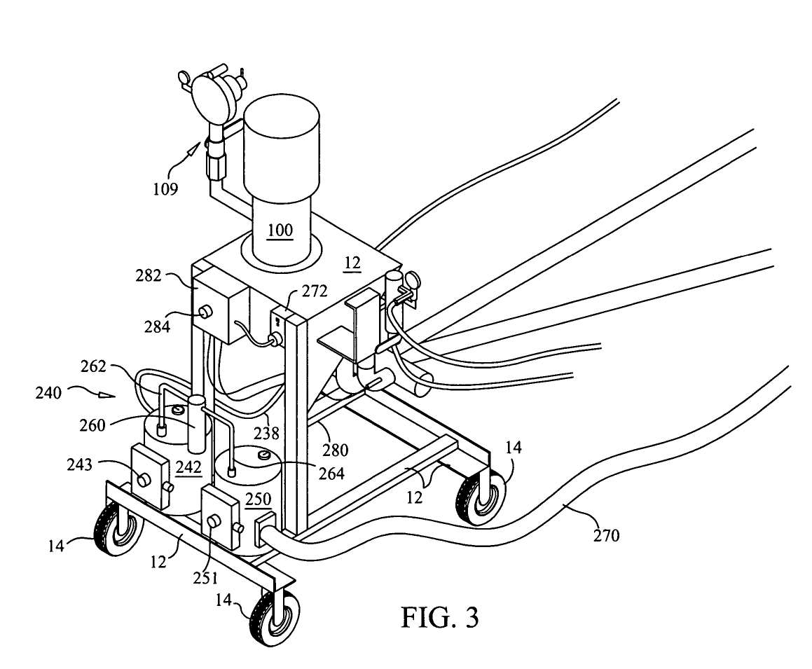

### DETAILED DESCRIPTION OF THE INVENTION

As seen in the drawings, a heated proportioned pump system is shown for use with an applicator assembly, such as a spray gun or spray wand, for applying coating, sealing and/or weatherproofing compositions, or other compositions or material(s). The pump system of the invention is generally designated as reference numeral 10. In the most preferred form, system 10 can be transported on a frame 12. Alternatively, the various components of system 10 can be provided on a truck, such as, but not limited to, a flat bed truck. Frame 12 can include a plurality of castors 14 or other wheel assemblies for easier moving of system 10. Frame 12 can also include one or more storage racks 15 for storing the various hoses of the invention when not in use. Storage racks can also be provided for frame 302.

As will be discussed fully below, pump system 10 includes proportioner pump 100, which receives the components/materials (collectively referred to as “component” or “components” throughout the description) in a predetermined proportion or ratio and sends the components in the desired ratio to an applicator 400 for spray application on a substrate. One of the components can also be sent through a heating assembly 240 prior to delivery to applicator 400.

A power assembly 300 can also be provided, preferably on a separate frame 302, though such is not considered limiting. Frame 302 can include castor or wheel assemblies 303 and can be constructed from aluminum, though other rigid materials can be used and are considered within the scope of the invention. Power assembly 300 can include an internal combustion engine, such as, but not limited to, a diesel engine. The engine preferably runs a conventional generator for generating electrical current, such as for electricity to one or more heated hoses and in-line heaters used with pump system 10. The electrical outlets, which are supplied power by the generator, can include outlets for providing 240 Volts AC, as well 120 Volts and/or special 120 Volts. An air compressor, having an air receiving tank, can also be driven by the engine. The air compressor is used to drive proportioner pump 100 and the feed pumps 42, 52 and 62 associated with the drums containing the components and the cleaning solution. A control box can be coupled with the engine and can serve to control the engine and/or the compressor. An ignition system can be provided for starting the engine. A cooling fan can also be provided for cooling the engine. The engine, generator, air compressor, and electrical outlets are all conventional components and are connected to each other as is conventionally known. As such, standard features and characteristics for the various components of power assembly 300, such as an alternator, oil pressure and water temperature shutdowns, gauges, controls, as well as other conventional items, can be provided, as would be apparent to one skilled in the art. The components of power assembly 300, though necessary to operate and provide power to heated pump system 10, are all conventional items and are not considered as the main part of the invention. Rather the main focus of the present invention is the various components that combine to form heated pump system 10 which is powered by power assembly 300.

Proportioner pump 100 includes a pumping assembly 102, a supply manifold 110 and supply tubes 130, 132 and 134. Supply manifold 110 can include a first internal passageway and a second internal passageway. An internal passageway of first supply tube 130 can be in communication with the first internal passageway of supply manifold 110. Similarly, an internal passageway of third supply tube 134 can be in communication with the second internal passageway of supply manifold 110.

In real life, the lower portion of pumping assembly 102 and supply tubes 130, 132 and 134 are typically more centrally disposed in relation to the upper portion of pumping assembly 102. However, so that these parts can be seen in the drawing figures, they have been drawn slightly offset from center. Proportioner pump 100 includes an air receiving assembly 109, which is connected or in communication with the air compressor of power assembly 300 through a hose line 101. Air receiving assembly is conventional and can include known parts such as, but not limited to, a bleed-type master air valve, pump air regulator, gauge(s), etc. Though not limiting, one type of proportioner pump 100 which can be used for the present invention pump system 10, is the PRESIDENT HYDRA-CAT fixed ration pump made by Graco, Inc. of Minneapolis, Minn. The ratio of power to pump 100 can be 10:1 (i.e. air in, component volume out). Pump 100 can be set to pump the two components in a set ratio to each other. In one embodiment, the approximately four units of the first component are pumped for every one unit of the second component. It should be understood that these ratios and values are not considered limiting and other ratios can be used and are considered within the scope of the invention.

A first component inlet hose connector 140, preferably having a filter disposed within its internal passageway, can be provided. The internal passageway can extend from a first end to a second end of first component inlet hose connector 140. Thus, when inlet hose connector 140 is properly connected to supply manifold 110, communication is provided between the internal passageway of inlet hose connector 140 and the first and second internal passageways of supply manifold 110. Connector 140 can also be constructed integral or monolithically formed with supply manifold 110.

A second component inlet hose connector 160, preferably having a filter disposed within its internal passageway, can be provided. The internal passageway can be preferably extended from a first end to a second end of second component inlet hose connector 160. The second (outlet) end second component inlet hose connector 160 can be connected to the inlet end of second supply tube 132, to provide communication between the internal passageway of inlet hose connector 160 and the internal passageway of second supply tube.

First component drum 40, includes an air operated feed pump 42 for drawing the first component out of drum 40. Feed pump 42 receives air from the compressor of power assembly 300 through hose 48 for operation. A first component inlet hose 44 is connected at one end to the component outlet of feed pump 42 and at its second end to an inlet of first component inlet hose connector 140.

Similarly, second component drum 50, includes an air operated feed pump 52 for drawing the second component out of drum 50. Feed pump 52 receives air from the compressor of power assembly 300 through hose 58 for operation. A second component inlet hose 54 is connected at one end to the component outlet of feed pump 52 and at its second end to an inlet of second component inlet hose connector 160.

The outputs of first supply tube 130 and third supply tube 134 can be both preferably fed to a first material/component manifold 170, preferably through a first tubing 172 connected at one end to the outlet of first supply tube 130 and at its second end to an inlet of a first portion 176 of manifold 170 and a second tubing 174 connected at one end to the outlet of third supply tube 134 and at its second end to an inlet of a second portion 178 of manifold 170. First portion 176 and second portion 178 are connected in series to each other to provide a continuous internal passageway for manifold 170. Pressure gauges 177 and 179 can be provided at first portion 176 and second portion 178, respectively, for reading the pressure of the material/component flowing therethrough. Manifold 170 includes a first outlet for directing the combined first component received within first portion 176 and second portion 178 to a heating assembly 240, via a hose 238, which will be discussed in more detail below.

A first return line assembly 180 includes a hose 181 and a pressure relief valve which can operate automatically or can be manually operated be a handle 182. Hose 181 can be connected at one end to manifold 170 and at its opposite end to drum 40. The amount of pressure which will cause the relief valve to automatically open can be preset. In one embodiment, the pressure value for the first return assembly can be set at any number falling in the range between approximately 1250 psi to approximately 2250 psi. However, it should be understood that this range of values is not considered limiting and other ranges of values can be selected and are considered within the scope of the invention.

Where there is too much pressure, which may indicate that the system is potentially being overloaded, the pressure relief valve is automatically activated, which causes the first component to flow into hose 181 and travel back to drum 40. The manual operation of the valve by handle 182 will also cause the first component to return to drum 40 through hose 181. The length of return hose 181 is preferably shorter than the length of the supply line to applicator 400, which, under the laws of fluid dynamics, causes the first component to enter return hose 181 rather than hose 238. In normal operations the relief valve is in a closed position, which leaves hose 238 as the only travel route for the first component entering into manifold 170.

Referring now to the travels of the second component, the output of second supply tube 132 can be preferably fed to a second material/component manifold 210, preferably through a third tubing 212 connected at one end to the outlet of second supply tube 132 and at its second end to an inlet of second manifold 210. A pressure gauge 211 can be provided for manifold 210 for reading the pressure of the second component flowing therethrough. Second manifold 210 includes a first outlet which can be preferably in communication with and connected to a filter assembly 220.

Where isocyanate, or other materials which may crystallize, is used for the second component and such material has been sitting within second supply tube 132, third tubing 212 and/or second manifold 210, the isocyanate may crystallize over time, which could clog applicator 400. Thus, filter assembly 220 filters any material that has crystallized. In one embodiment, filter assembly 220 can include a high pressure fluid filter, though other filters can be used and are considered within the scope of the invention.

A first end of a hose 221 is connected to the outlet of filter assembly 220, or if no filter assembly 220 is provided, the first outlet of second manifold 210. The second end of hose 221 is connected to the applicator 400, such that the second component becomes one of the inputs to applicator 400. Depending on the material(s) or components traveling into first supply tube 130 and/or third supply tube 134, a filter assembly, which can be similar to filter assembly 220, can be provided, which may similarly change the connection points of first return assembly 180 and hose 238.

A second return line assembly 224 includes a hose 225 and a pressure relief valve which can operate automatically or can be manually operated be a handle 226. Hose 225 can be connected at one end to manifold 210 and at its opposite end to drum 50. The amount of pressure which will cause the relief valve to automatically open can be preset. In one embodiment, the pressure value for the second return assembly can be set at any number falling in the range between approximately 750 psi to approximately 1250 psi. However, it should be understood that this range of values is not considered limiting and other ranges of values can be selected and are considered within the scope of the invention.

Where there is too much pressure, the pressure relief valve is automatically activated (“opened”), which causes the second component to flow into hose 225 and travel back to drum 50. The manual operation of the valve by handle 226 will also cause the second component to return to drum 50 through hose 225. The length of return hose 225 is preferably shorter than the length of hose 221 which is connected to applicator 400, which causes the second component to enter return hose 225 rather than hose 221. In normal operations the relief valve is in a closed position, which leaves hose 221 as the only travel route for the second component entering into manifold 170.

As discussed above, a first end of hose 238 is connected to first manifold 170. The second end of hose 238 is connected to an inlet of a first heater 242 of heating assembly 240. First heater 242 is provided with an internal passageway for the first component received through hose 238. The first component flow through internal passageway allows it to be heated while traveling therein. As the first component does not reside in first heater 242 for a relatively significant period of time, the first component may not be sufficiently heated to its desired temperature while within first heater 242. To further heat the first component, a second heater 250 can be provided. Heaters 242 and 250 can be high pressure fluid heaters.

To slow down the rate of flow for the component and thus increase its time within heaters 242 and 250, a heat resonator 260 can be provided in between and in series with heaters 242 and 250. A first end of heat resonator 260 can be attached to an outlet of first heater 242 and the second end of heat resonator 260 can be attached to an inlet of second heater 250. To slow down the speed of travel for the first component, which will allow it to be exposed longer to heat, the inner diameter of an internal passageway of an inlet portion 262 of heat resonator 260 is larger then the inner diameter of the internal passageway of an outlet portion 264 of heat resonator 260. This causes the first component to hold back and slow down. By way of example only, in one embodiment, the inner diameter of the internal inlet passageway can be approximately ⅜″ and the inner diameter of the outlet passageway can be approximately ¼″. In this example, the inner diameter of the outlet passageway is reduced by approximately 25%. However such dimensions are not considered limiting and other dimensions can be provided and are considered within the scope of the invention. Thus, the slowing down of the rate of flow for the first component by heat resonator 260 and the addition of second heater 250 permits the component to be heated to the proper temperature.

Heating assembly 240 is preferably provided to help reduce the viscosity of the first component traveling therethrough so that it will spray properly out of applicator 400. To help maintain the temperature of the heated first component once it leaves heating assembly 240, a heated hose 270 can be connected at one end to the outlet of second heater 250. The other end of heated hose is connected to applicator 400.

In use, the air compressor from power assembly 300 operates proportioner pump 100 such that it pumps the respective components in preselected ratio from drums 40 and 50 in conjunction with feed pumps 42 and 52 associated with drums 40 and 50, respectively. The air compressor also operates feed pumps 42 and 52, as well as feed pump 62 associated with drum 60 containing the cleaning solution used for flushing applicator 400 after its use.

The first component is drawn from drum 40 and travels through supply hose 44, first inlet member 140 where it splits into two portions. Preferably, the portions can be equally split. A first portion travels through first supply tube 130 and the second portion travels through third supply tube 134. The two portions of the first component are combined again at first manifold 170 to again form a single route of travel for the first component. At this point the first component travels through hose 238 for entry into the heating assembly 240.

To lower the viscosity of the first component, which improves its spray characteristics out of applicator 400, heaters 242 and 250, in conjunction with heat resonator 260, heat the first component to the desired temperature. After traveling through heating assembly 240, the heated first component is sent through heated hose 270 connected at one end to the outlet of heating assembly 240. The other end of heated hose 270 is connected as a first input to applicator 400. Heated hose 270 helps to maintain the temperature of the first component at or close to the temperature it was heated to during its travels through heating assembly 240. Power for heated hose 270 can be provided by an outlet 272 disposed on frame 12 or by an outlet provided by power assembly 300. Power to the outlets is derived from the generator of power assembly 300.

The second component is drawn from drum 50 and travels through supply hose 54 to second inlet member 160 and through second supply tube 132 to second manifold 210 and through filter assembly 220, if a filter assembly 220 is provided. A first end of hose 221 is connected to the outlet of filter assembly 220. The second end of hose 221 is attached as the second input of applicator 400. The second component travels through hose 221 and into applicator.

The first and second components are mixed together by applicator 400 and are sprayed out of the outlet nozzle of applicator 400 onto the desired substrate or surface. Applicator 400 can be one of the applicators disclosed in two of my pending patent applications (U.S application Ser. No. 10/072,325, filed on Feb. 7, 2002 and a recently filed continuation-in-part application therefrom filed on Jun. 2, 2003, both entitled Spray Gun Applicator), which are both incorporated by reference. Other applicators can also be used.

Additionally, system 10 can be provided with conventional metal, aluminum, plastic and/or plumbing connectors for connecting the various hoses, pipes and tubes of and used with the present invention. Though the term “drum” is used for the description, such term shall also include, containers, buckets, cans. In one embodiment a drums 40 and 50 are 5 gallon drums, though such value is not considering limiting and other dimensions can be used and are considered within the scope of the invention. Additionally, where appropriate, referring to a part as a “hose” shall also mean that such part can be a pipe, tubing, cylinder, etc.

A source of cleaning material (i.e. naphta, mineral spirits, etc.) can be provided in drum 60 for cleaning the applicator.

Proportioner pump 100 draws the first and second components in the desired set or programmed ratio amount, which in one embodiment can be a 4:1 ratio, though such is not considered limiting. The present invention is not limited to any specific ratio setting for proportioner 100 and all various combinations (e.g. 4 to 1, 3 to 1, etc.) can be used and are considered within the scope of the invention.

Heated hose 270 can include a heating element, which surrounds the hose and a heating unit, which powers and controls the heating element. The heated hose can be heated by a sheath, which surrounds the hose. As an example, a heating element may be woven into the sheath, and as it is energized, it generates thermal energy, which is transferred through the sheath to the hose. In one preferred embodiment, the heating element can be an electrical coil, which can be energized by plugging into an electrical outlet 272 powered by the generator (i.e. receives electric current from the generator). The heating element can generate an electrical current through a wire (or wires) that is coiled about the outer circumference of the hose. The hose is preferably heated right up to its connection. However, any appropriate combination of a heating element and heating unit, including but not limited to, electric coils, heated fluid or hydraulic coils, heated air coils, or any type of convective or conductive heating element may be utilized to heat hose 270 and all are considered within the scope of the invention.

Lastly, one or more fire rods (heating elements) 280 can be introduced into the internal passageway of first supply tube 130 and third supply tube 134 for further heating the first component, particularly in cold weather locations, though not limited to cold weather situations. Power and temperature settings for rods 280 can be controlled by knob 284 and control box 282. Similarly, temperature settings for heaters 242 and 250 can be controlled at knobs 243 and 251.

Pumps 42 and 52 can be 1:1 feed pumps, though such is not considered limiting.

By having different pressure settings for the respective relief valves of the return assemblies, system 10 also helps to ensure that it does not run out of the second component.

Heated hose can preferably run from anywhere between approximately 0° F. and approximately 350° F., and preferably approximately 325° F. None of these temperatures and ranges are considered limiting. Furthermore, system 10 is not intended for use for any single purpose and can be used for a variety of purposes and applications, as well as for a variety of materials and components. Additionally, system 10 is not limited to the use of two components and all combinations are considered within the scope of the invention, and is not limited to any particular types of materials.

It should be also recognized that many of the hoses used for system 10 could also be tubing or rigid or flexible pipes or piping. Likewise many of the pipes or piping could also be hoses. Thus, the invention is not limited to any one specific type of fluid or material transporter and use of words such at tubing, pipes, hoses, fluid or material lines, lines, etc. throughout the application and claims are considered to be broadly interpreted to encompass all types of fluid or material transporters.

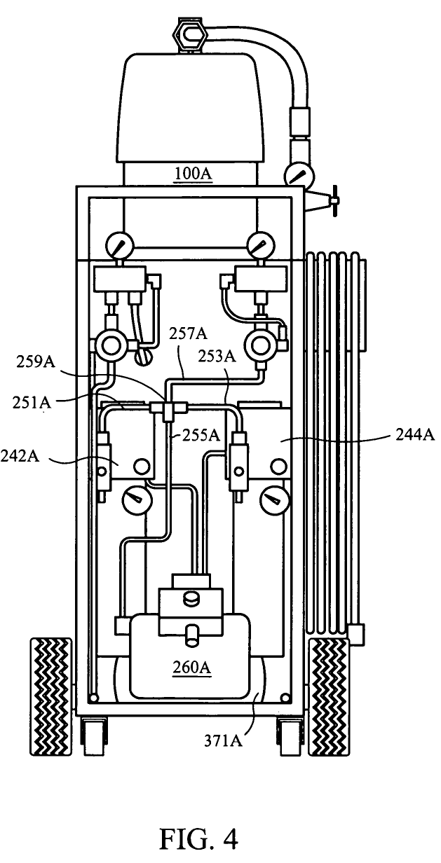

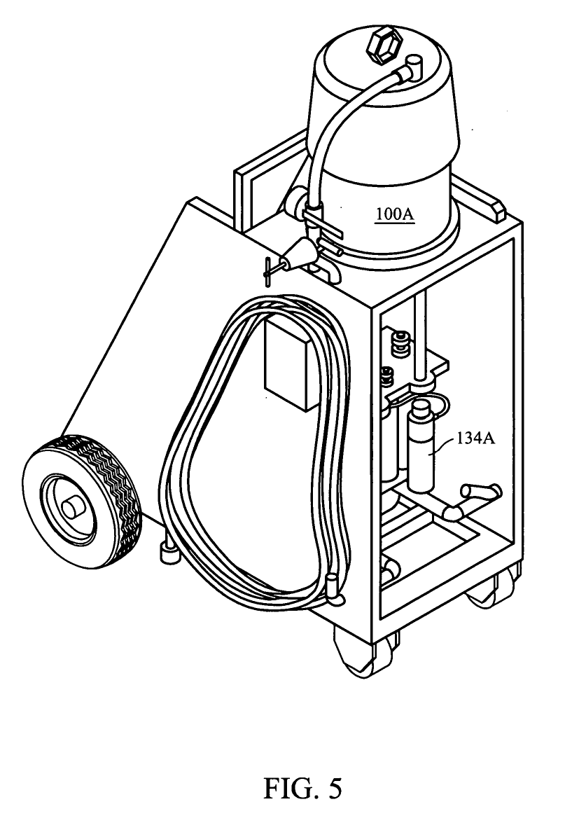

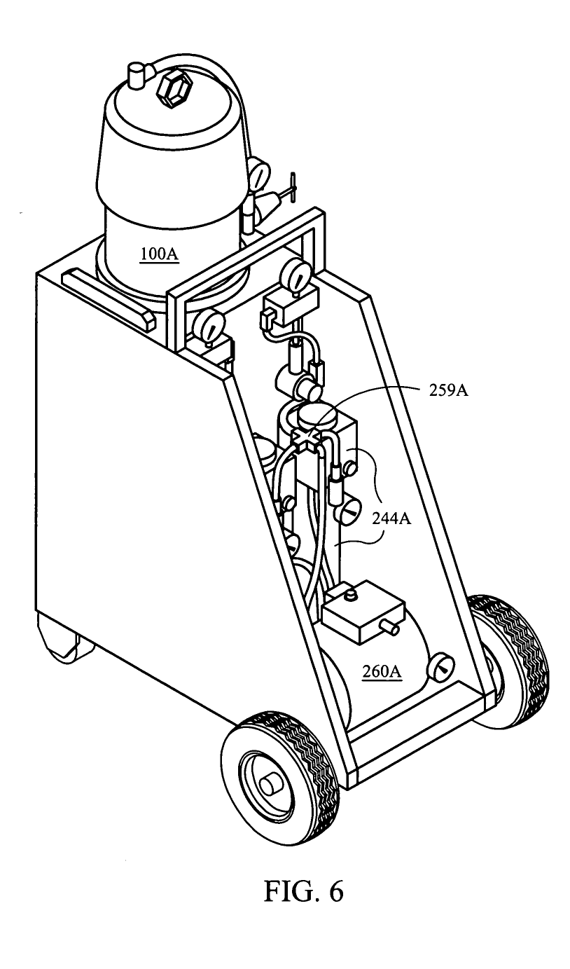

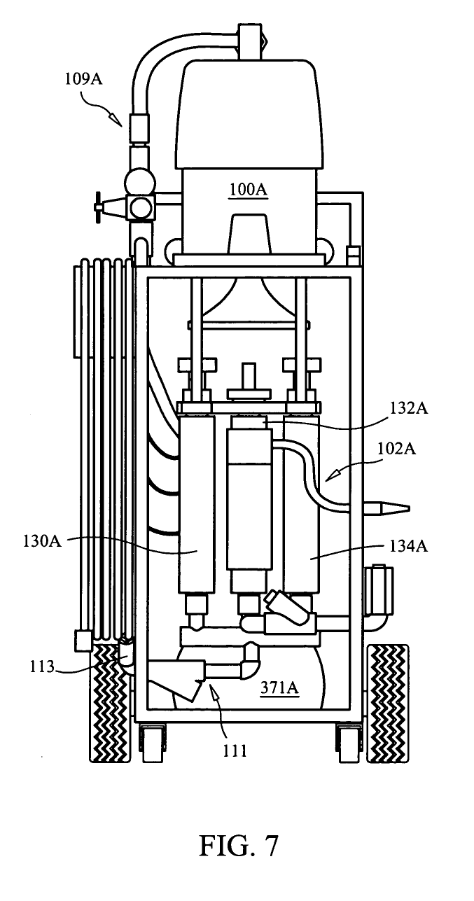

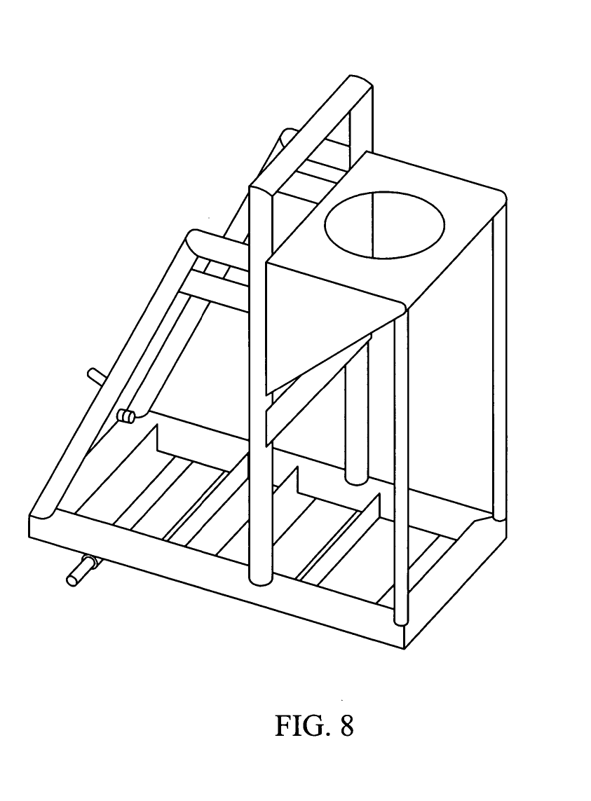

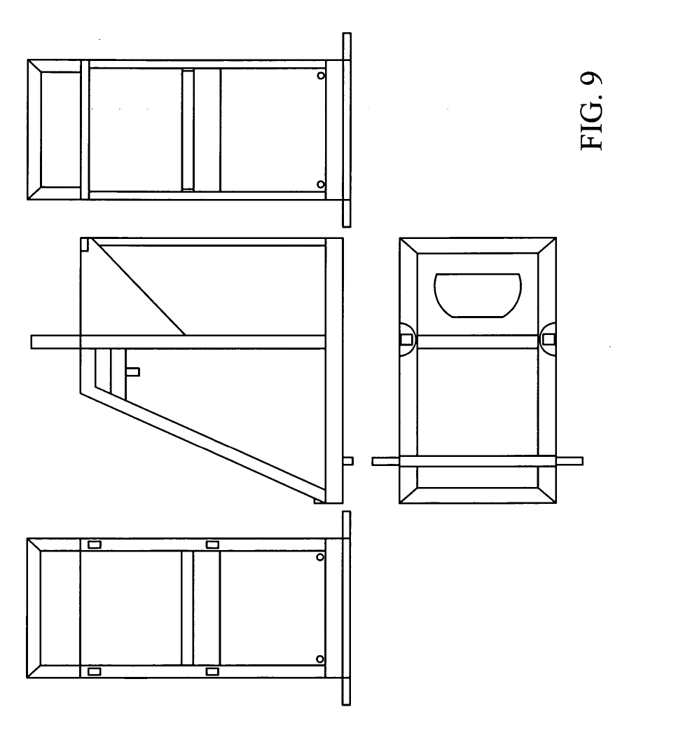

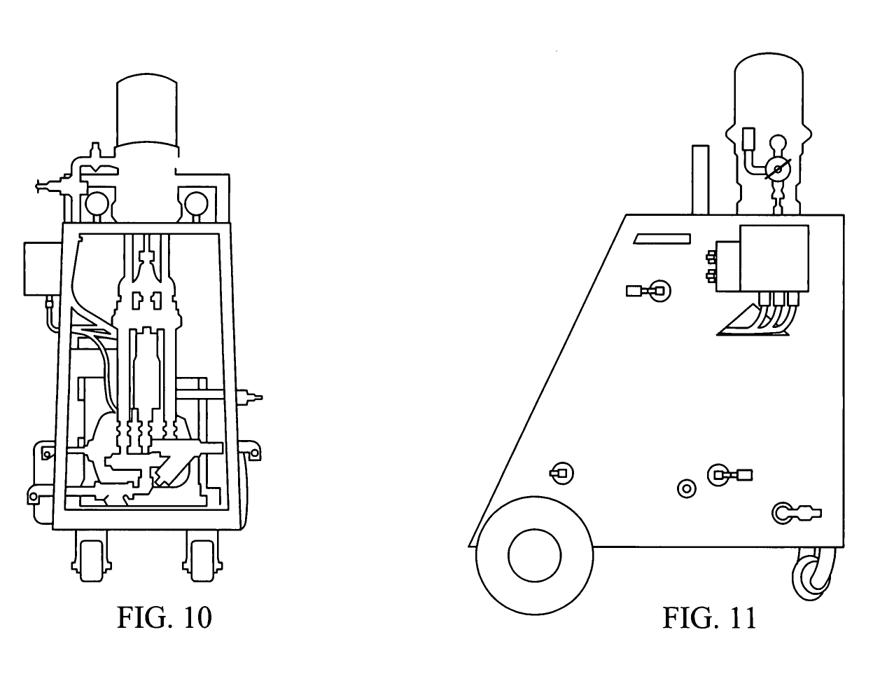

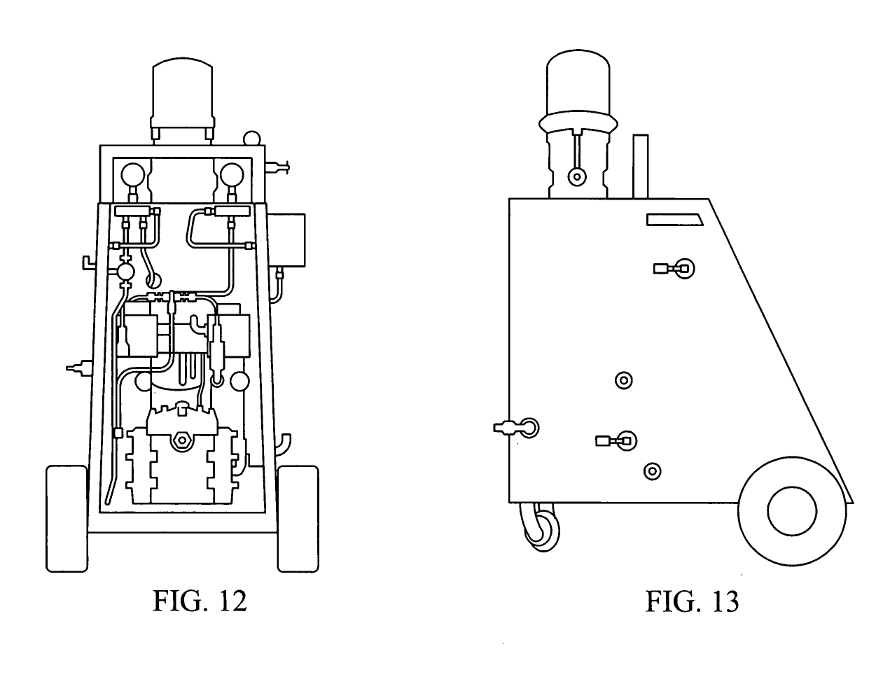

FIGS. 4 through 13 show a second embodiment of the present invention assembly. Many of the components of the second embodiment are similar or identical to those discussed for the first embodiment and/or operate similar to the first embodiment components. A proportioner pump 100A is provided and can include a pumping assembly 102A, a supply manifold 110A and supply tubes 130A, 132A and 134A. Supply manifold 110A can have an internal passageway for entry of a first component (material(s)) through a hose, conduit, tubing, etc. (collectively referred to as “hose”). Similar to the first embodiment (with the exception of the location of the air reservoir) the first component can be stored in a drum or similar container (collectively referred to as “drum”). A first material entry or feed line 111 can be provided and is can be in communication with the internal passageway of supply manifold 110A. Feed line 111 can be provided with an internal filter and a hose connector or hose connection point 113. Alternatively, a hose connector or hose connection point can be provided with supply manifold 110A for directly attaching the drum hose to supply manifold 110A.

An internal passageway of first supply tube 130A can be in communication with the internal passageway of supply manifold 110A. Similarly, an internal passageway of third supply tube 134A can also be in communication with the internal passageway of supply manifold 110.

Proportioner pump 100A can include an air receiving assembly 109A, which is connected similar to the first embodiment or through an air tank 371A on the frame which is discussed in detail below.

Though not limiting, certain types of proportioner pumps 100 which can be used for the present invention pump system 10, can be the BULLDOG or PRESIDENT HYDRA-CAT fixed ratio pump made by Graco, Inc. of Minneapolis, Minn. The ratio of power to pump 100 can be 10:1 (i.e. air in, component volume out). Pump 100 can be set to pump the two components in a set ratio to each other. In one embodiment, the approximately four units of the first component are pumped for every one unit of the second component. It should be understood that these ratios and values are not considered limiting and other ratios can be used and are considered within the scope of the invention. Furthermore, other proportioner pumps can be used and are considered within the scope of the invention.

A second component entry or feed line 160A and hose connector or hose connection point 161A, preferably having a filter disposed within the internal passageway of feed line 160A can be provided. Feed line 160A is preferably in communication with second supply tube 132A. Alternatively, the hose connector for the second material can be directly connected to supply tube 132A.

Similar to the first embodiment, the first component storage drum can include an air operated feed pump for drawing the first component out of the drum 40. For operation the feed pump receives air from the compressor of the power assembly (similar to the first embodiment) or through air tank 371A. A first component inlet hose can be provided for connecting the pump to its air source.

Similarly, the second component storage drum can include an air operated feed pump for drawing the second component out of the drum. The feed pump also can receive air from the air compressor or air tank 371A. A second component inlet hose can be provided for connecting the pump to its air source.

The output of first supply tube 130A is sent to an inlet of a first primary heater 242A via a hose 131 A. Similarly, the output of third supply tube 134A is sent to an inlet of a second primary heater 244A via a hose 135A. Pressure and/or temperature gauges can be provided for reading the pressure and/or temperature of the material/component flowing therethrough.

The first component traveling through heater 242A exits heater 242A through the heater's outlet and the first component traveling through heater 244A exits heater 244A through the heater's outlet. A first hose 251A is connected at one end to the outlet of heater 242A and at its second end to a first inlet of a junction or T plumbing fitting 259A. A second hose 253A is connected at one end to the outlet of heater 244A and at its second end to a second inlet of fitting 259A. The first component heated by first heater 242A and traveling through first hose 251A meets and is combined with the first component heated by second heater 244A and traveling through second hose 253A at fitting 259A. At this point the combined first component travels through a third hose 255A to a final heater 260A unless a first component return valve 281A is opened or otherwise activated to direct the combined first component back to its storage drum via a fourth hose 257A in communication with a first component return assembly 180A. Third hose 255A and fourth hose 257A are connected to outlets of fitting 259A.

For similar purposes described above for the first embodiment, a first return line assembly 180A can be provided for returning the first component back to the drum under certain conditions. The return assembly can include a first return hose connected to the first component drum and an a first return outlet 283A. Fourth hose 257A is in communication with first return outlet and thus in communication with the first return hose. A pressure relief valve can operate automatically or can be manually operated be a handle 182A. The amount of pressure which will cause the relief valve to automatically open can be preset. In one embodiment, the pressure value for the first return assembly can be set at any number falling in the range between approximately 1250 psi to approximately 2250 psi. However, it should be understood that this range of values is not considered limiting and other ranges of values can be selected and are considered within the scope of the invention.

Where there is too much pressure, which may indicate that the system is potentially being overloaded, the pressure relief valve can be automatically activated, which causes the first component to flow out of fitting 259A into fourth hose 257A and back to return assembly 180A for return back to the drum it originated from. The manual operation of the valve by handle 182A will also cause the first component to return to the drum by similar travels. The length of return hose can be preferably shorter than the length of the supply line to the spray applicator. In normal operations the relief valve is in a closed position, which causes the combined first component to travel through third hose 255A for travel to final heater 260A. The second end of third hose 255A can be connected to the inlet of final heater 260A.

The travels of the second component after leaving supply tube 132A is similar to the travels of the second component leaving supply tube 132 for the first embodiment. The output of second supply tube 132A can be preferably fed to a second material/component manifold 210A, preferably through hose 212A connected at one end to the outlet of second supply tube 132A and at its second end to an inlet of second manifold 210A. A pressure gauge 211A can be provided for manifold 210A for reading the pressure of the second component flowing therethrough. Second manifold 210A can include a first outlet which can be in communication with and connected to a filter assembly (similar to the first embodiment), though such is not considered limiting. Where the filter assembly is provided it can be connected and used for purposes similar to filter assembly 220 discussed above for the first embodiment.

A second component outlet 291A can be provided and is in communication with either manifold 210A or the filter assembly (if provided) through a dispense line 211. The hose running from second component outlet 291A to the applicator is similar to that described above for the first embodiment.

A second return line assembly 224A can be provided and can include a return line 229A, a return hose and pressure relief valve 225A. Assembly 224A can operate automatically or can be manually operated be a handle 226A. Return assembly 224A can either be connected and in communication with manifold 210A or the filter assembly (if provided). Return line assembly can include a return hose connection outlet 227A. The return hose can be connected to outlet 227A and a second component storage drum. The amount of pressure which will cause the relief valve to automatically open can be preset. In one embodiment, the pressure value for the second return assembly can be set at any number falling in the range between approximately 750 psi to approximately 1250 psi. However, it should be understood that this range of values is not considered limiting and other ranges of values can be selected and are considered within the scope of the invention.

Where there is too much pressure, the pressure relief valve is automatically activated (“opened”), which causes the second component to flow through return line 229 and into the return connected at outlet 227A for traveling back to the second component storage drum. The manual operation of the valve by handle 226A causes a similar return trip for the second component back to the second component storage drum. The length of the return hose can be preferably shorter than the length of hose which is connected to applicator 400. In normal operations the relief valve is in a closed position, which leaves the only travel route for the second component through dispense line 211 and ultimately to the applicator.

As discussed above, third hose 255A is connected to the inlet of final heater 260A for travel of the combined first component through heater 260A. The first component flowing through the internal passageways of heaters 242A, 244A and 260A allows the first component to be heated while traveling therein. Final heater 260A can be provided to ensure that the combined first component is maintained at its desired temperature for delivery to the applicator.

The heating of the first component is preferably provided to help reduce the viscosity of the first component traveling therethtough so that it will spray properly out of the applicator. To help maintain the temperature of the heated first component once it leaves final heater 260A, a heated hose (similar to that discussed for the first embodiment) can be connected at one end to the first component dispense outlet 295A which can be in communication with final heater 260A through a dispense line 261A. Alternatively the first component dispense outlet or the heated hose can be connected directly to the outlet of final heater 260A. The other end of heated hose is connected to the applicator.

An air tank 371A having multiple outlets 373A and an inlet 375A can be provided on the frame for providing an air manifold and supplementary source of air for volumetric displacement. A first hose is attached at one end to a first outlet of outlets 373A and at its second end to proportioner 100A for driving proportioner 100A. A second hose is attached at one end to a second outlet of outlets 373A and at its second end to a feed pump associated with the first component storage drum. A third hose is attached at one end to a third outlet of outlets 373A and at its second end to a feed pump associated with the second component storage drum. A conventional air compressor is in communication with air tank 371A and feeds air tank 371A at its inlet 375A. Additional inlets and outlets can be provided for air tank 371A.

The use of air tank 371A eliminates or at least reduces issues of feed hose restriction to air motor. By way of non-limiting example, the pumps of the assembly can use a lot of air −40 cfm to 60 cfm. Most air hoses and supply systems use ⅜ or ½ air line. Each stroke of pump uses 1 cubic foot of air.

Air tank 371A reduces if not eliminates air surge and supplies the air motor adequate air supply during stroking at most critical interval, change over. Change over is terminology used to describe air motor reciprocation. As motor changes from stroking up, to stroking down, air motor exausts and new air enters chamber. Supply can be important at this point to eliminate stalling—throwing material off ratio.

However, it should be recognized that the second embodiment of the invention can be used without air tank 371A with the air compressor as the sole source of air. Similarly, the first embodiment of the invention can be configured to also include an air tank 371A.

In use for the second embodiment, air tank 371A operates proportioner pump 100A such that it pumps the respective components in preselected ratio from the storage drums in conjunction with the feed pumps associated with the drums. Air tank 371A also operates the storage drum feed pumps and can also operate the feed pump associated with a cleaning solution storage drum.

The first component is drawn from its storage drum and travels through its supply hose where it splits into two portions, one portion going to supply tube 130A and one portion going to supply tube 134A. Preferably, the portions can be equally split. The first portion travels from the first supply tube to first primary heater 242A and the second portion travels through the third supply tube to second primary heater 244A. The two portions of the first component are combined at fitting 255 which is in communication with both primary heaters at their outlets, to form a single route of travel for the first component to the inlet of the final heater. After traveling through final heater 260A, the heated first component is sent to the spray application, preferably through heated hose connected at one end to a first component dispense outlet. The other end of heated hose is connected as a first input to the applicator. Power for the heated hose and all other components comes from the power aassmbly (generator) or other power source, similar to the first embodiment of the invention.

The second component travels similar to that described for the first embodiment, where it ultimately becomes the second input to the applicator. Also similar to the first embodiment, the first and second components are mixed together by the applicator and are sprayed out of the outlet nozzle of applicator onto the desired substrate or surface. The applicator can be one of the applicators disclosed in two of my pending patent applications (U.S. application Ser. No. 10/072,325, filed on Feb. 7, 2002 and a recently filed continuation-in-part application therefrom filed on Jun. 2, 2003, both entitled Spray Gun Applicator), which are both incorporated by reference. Other applicators can also be used.

Additionally, the embodiments of the invention can be provided with conventional metal, aluminum, plastic and/or plumbing connectors for connecting the various hoses, pipes and tubes of and used with the present invention. Though the term “drum” is used for the description, such term shall also include, containers, buckets, cans. In one embodiment a drums 40 and 50 are 5 gallon drums, though such value is not considering limiting and other dimensions can be used and are considered within the scope of the invention. Additionally, where appropriate, referring to a part as a “hose” shall also mean that such part can be a pipe, tubing, cylinder, etc.

A source of cleaning material (i.e. naphta, mineral spirits, etc.) can be provided in drum 60 for cleaning the applicator.

Proportioner pump 100 or 100A draws the first and second components in the desired set or programmed ratio amount, which in one embodiment can be a 4:1 ratio, though such is not considered limiting. The present invention is not limited to any specific ratio setting for proportioner 100 or 100A and all various combinations (e.g. 4 to 1, 3 to 1, etc.) can be used and are considered within the scope of the invention.

The heated hose can include a heating element, which surrounds the hose and a heating unit, which powers and controls the heating element. The heated hose can be heated by a sheath, which surrounds the hose. As an example, a heating element may be woven into the sheath, and as it is energized, it generates thermal energy, which is transferred through the sheath to the hose. In one preferred embodiment, the heating element can be an electrical coil, which can be energized by plugging into an electrical outlet powered by the generator (i.e. receives electric current from the generator). The heating element can generate an electrical current through a wire (or wires) that is coiled about the outer circumference of the hose. The hose is preferably heated right up to its connection. However, any appropriate combination of a heating element and heating unit, including but not limited to, electric coils, heated fluid or hydraulic coils, heated air coils, or any type of convective or conductive heating element may be utilized to the heat hose and all are considered within the scope of the invention.

The feed pumps can be 1:1 feed pumps, though such is not considered limiting.

Where different pressure settings are provided for the respective relief valves of the return assemblies, the systems also help to ensure that it does not run out of the second component.

The Heated hose can preferably run from anywhere between approximately 0° F. and approximately 350° F., and preferably approximately 325° F. None of these temperatures and ranges are considered limiting. Furthermore, both embodiments are not intended for use for any single purpose and can be used for a variety of purposes and applications, as well as for a variety of materials and components. Additionally, both embodiments are not limited to the use of two components and all combinations are considered within the scope of the invention. Furthermore, the embodiments are not limited to any particular types of materials.

It should be also recognized that many of the hoses used for both embodiments of the invention could also be tubing or rigid or flexible pipes or piping. Likewise many of the pipes or piping could also be hoses. Thus, the invention is not limited to any one specific type of fluid or material transporter and use of words such at tubing, pipes, hoses, fluid or material lines, lines, etc. throughout the application and claims are considered to be broadly interpreted to encompass all types of fluid or material transporters. Additionally, the various feed lines discussed above are not considered limited to any particular arrangement or configuration of hoses, piping, fittings, valves, etc. and other configurations that sufficiently permit the material or component to travel where desired can be used and are considered within the scope of the invention.

The instant invention that has been shown and described herein is considered to be the most practical and preferred embodiment. It is recognized, however, that departures may be made therefrom within the scope of the invention and that obvious modifications will occur to a person skilled in the art.

1. A pump assembly comprising:
means for supplying a first component and a second component in a fixed ratio;
means for heating the first component in communication with a first component outlet of said means for supplying;
wherein the first component is fed out of said means for heating as a first input to a spray applicator and the second component is fed by said means for supplying as the second input to the spray applicator.

2. The pump assembly of claim 1 further including means for returning said first component to a storage drum under certain conditions.

3. The pump assembly of claim 1 further including means for returning said second component to a storage drum under certain conditions.

4. The pump assembly of claim 1 wherein said means for supplying divides the first component into two portions with a first portion being sent to a first primary heater and a second portion being sent to a second primary heater; wherein the first portion and second portion are combined after traveling through the primary heaters and are fed through a final heater prior to being sent to the spray applicator.
